(19) United States
(12) Patent Application Publication
(10) Pub. No.: US 2008/0283330 A1
(43) Pub. Date: Nov. 20, 2008

(54) Torsional-Vibration Damper Connected to Crankshaft and Combination of Torsional-Vibration Damper and Clutch

(76) Inventors: Till Ebner, Seeheim (DE); Volker Heinz, Roemerberg (DE); Dietmar Ernst Strauss, Kraichtal (DE); Christian Halm, Walldorf (DE); Jochen Bolling, Baden-Baden (DE)

Correspondence Address: BLISS MCGLYNN, P.C., 2075 WEST BIG BEAVE ROAD, SUITE 600, TROY, MI, 48084, US

(21) Appl. No.: 12/092,421

(22) PCT Filed: Nov. 2, 2006
(86) PCT No.: PCT/EP2006/010538

§ 371 Date: Aug. 5, 2008

(30) Foreign Application Priority Data
Nov. 4, 2005 (DE) 10 2005 053 073.7
Jan. 26, 2006 (DE) 10 2006 003 955.6

(51) Int. Cl. B60K 17/22

(52) U.S. Cl. 180/381; 180/292

(57) ABSTRACT

A torsional-vibration damper T is adapted to be connected to a crankshaft 2 of a motor vehicle. The torsional-vibration damper T includes a primary element 5 of a drive side thereof connected indirectly or directly to the crankshaft 2 substantially free of play in an axial direction “ax.” A secondary element 6 of an output side of the torsional-vibration damper T is substantially coaxially coupled rotatably and spring-elastically to the primary element 5 for transmission of rotational movement.

### BACKGROUND OF THE INVENTION

1. Field of the Invention

The present invention relates, generally, to a torsional-vibration damper for use with a motor vehicle and, particularly, to a torsional-vibration damper adapted to be connected to a crankshaft and combined with a clutch of a motor vehicle.

2. Description of the Related Art

Torsional- or rotary-vibration dampers are known from the related art in a multiplicity of modifications and various areas of use. In particular, they are employed in motor-vehicle construction for elastic coupling of an internal-combustion engine and a drive train. This is intended to prevent vibrations from being transmitted from an internal-combustion-engine side to the drive train or a transmission. Such a transmission of vibrations occurs in motor-vehicle drives, above all in an internal-combustion engine having comparatively few cylinders and at low rotational speeds. With an effective damping of such vibrations, the internal-combustion engine can be operated at lower rotational speeds. This generally results in reduced fuel consumption and, therefore, is advantageous both economically and ecologically.

A torsional-vibration damper with a primary element of a drive side thereof and a secondary element of an output side thereof are known from EP 1 371 875 A1 and DE 195 22 718 A1. The primary and secondary elements are coupled to one another in a circumferential direction via a spring device and rotatable with respect to one another about a neutral position. The primary element includes a primary dog, and the secondary element includes a secondary dog. A torque prevailing at the primary element is transmitted by the primary dog to the spring device and then to the secondary dog.

The spring device includes, for example, one or more spring elements that are arranged one behind the other in the circumferential direction of an annular part of the torsional-vibration damper and preferably designed as helical springs or helical-spring sets. Sliding shoes are arranged between successive spring elements to connect the spring elements to one another. End shoes are arranged at both ends of the spring device to support the spring device against the respective dogs. Instead of sliding shoes, divider plates may also separate the successive spring elements from one another. Design variants are described, for example, in European Patent Application 04 008 489.9.

Transmission of torque from the primary element to the secondary element in a torsional-vibration damper is designated as “overrun.” Transmission of torque in the opposite direction from the secondary element to the primary element is called “traction.”

If a torsional-vibration damper of this type is coupled to an output shaft of the transmission directly or, for example, with a clutch—such as a double clutch—being interposed, an increased tendency to premature wear of the components following the torsional-vibration damper is repeatedly observed. This increased tendency to premature wear is accompanied, as a rule, by an increased generation of noise in the torsional-vibration damper/transmission or torsional-vibration damper/clutch/transmission. A further noise source arises from insufficiently supported masses that may lead to greater unbalances.

Also, when a clutch/damper module is in operation, movement irregularities and noises, among other things, arise in that a primary mass, that is to say, the drive side, is not connected, free of play, to an engine mass. This may give rise in axial and radial directions to a play that, in the case of occasionally irregular movements of a crankshaft, may lead to relative movements, such as rattling, with generation of noise and wear. By contrast, in the case of a play-free tie-up, there have hitherto generally been problems with manufacturing tolerances that have to be compensated during assembly of the engine/transmission.

And, in torsional-vibration dampers, there is generally between the primary element and secondary element a play in the radial direction with respect to an axis of rotation. Furthermore, because of manufacturing tolerances, there is always a risk of occurrence of unbalances in the case of rotating parts, such as in the case of the primary and secondary elements. In addition, radial offsets often arise between a shaft driving the torsional-vibration damper on the drive side thereof, the primary and secondary elements themselves, and, for example, an output shaft or a following clutch. Insofar as there is a comparatively rigid connection between the torsional-vibration damper and other components, unbalances, radial offsets, or the like cause radial forces that are transferred from the torsional-vibration damper to the components and also give rise there to increased wear and noise generation. Moreover, during a drive movement of the crankshaft, movements in the axial direction also occur unavoidably.

Thus, there remains a need in the related art for a torsional-vibration damper that is designed and developed in such a way that it and components connected on the output side tend to prematurely wear to a lesser extent than do systems or torsional-vibration dampers according to the related art. There remains a need in the related art also for such a torsional-vibration damper that is designed and developed in such a way that generation of noise during its operation is reduced.

### SUMMARY OF THE INVENTION

The present invention overcomes the disadvantages in the related art in a torsional-vibration damper that is adapted to be connected to a crankshaft of a motor vehicle. The torsional-vibration damper includes a primary element of a drive side thereof connected indirectly or directly to the crankshaft substantially free of play in an axial direction. A secondary element of an output side of the torsional-vibration damper is substantially coaxially coupled rotatably and spring-elastically to the primary element for transmission of rotational movement.

One advantage of the torsional-vibration damper of the present invention is that it and components connected on the output side tend to prematurely wear to a lesser extent than do systems or torsional-vibration dampers according to the related art and the torsional-vibration damper reduces generation of noise during its operation.

Another advantage of the torsional-vibration damper of the present invention is that it may configure play-free connections as fixed or even releasable joining connections and play-free coupling in the axial direction to initially prevent generation of noise and relative movement between the crankshaft and, if appropriate, a flywheel, a flexible plate, and the primary element of the torsional-vibration damper, depending upon which parts are in a drive chain.

Another advantage of the torsional-vibration damper of the present invention is that it can absorb unavoidable movements particularly simply in the axial direction during a drive movement of the crankshaft in a region of the torsional-vibration damper at a low outlay in structural terms.

Another advantage of the torsional-vibration damper of the present invention is that it provides for the primary element to be connected to the flywheel, which is connected substantially free of play axially to the crankshaft, and a joining connection between the primary element and flywheel for compensation of tolerances during assembly.

Another advantage of the torsional-vibration damper of the present invention is that it may reinforce dampening of irregular movements, dampen vibrations, and compensate radial or axial offsets and tiltings of axes of rotation with respect to one another and effectively limits axial play in a drive train between an engine, the crankshaft, and the torsional-vibration damper.

Another advantage of the torsional-vibration damper of the present invention is that it allows movement of the primary or secondary element in the axial direction for compensation of axial movement of the other element and provides for the primary element to be mounted indirectly or directly in the axial direction on a rotatable part connected to the secondary element and play of the rotatable part in the axial direction to be greater than axial play of the crankshaft and primary element.

Another advantage of the torsional-vibration damper of the present invention is that it reduces rattling noises and a higher wear or noise generation due to unbalances, prevents wear due to axial knocking by individual parts being mounted against one another in the axial direction, and achieves a more exact tie-up to the secondary element.

Another advantage of the torsional-vibration damper of the present invention is that it allows, during assembly, the drive train to be joined together with unbalances as minimized as possible, thus leading to an increase in synchronism both in the axial direction and a circumferential direction.

Another advantage of the torsional-vibration damper of the present invention is that it provides space and an effective shielding, absorbing, or compensating of radial forces, which is an integral part of the secondary element, and prevents parasitically occurring radial forces from being transferred to following components, such as a (double) clutch.

Another advantage of the torsional-vibration damper of the present invention is that it allows overall clutch play to be set independently of a play setting on the torsional-vibration damper such that damper structures may be used that dispense completely with the play setting or the primary element, as a flexible element, makes the clutch/damper independent of axial movements of a drive shaft, such as the crankshaft.

Another advantage of the torsional-vibration damper of the present invention is that it shields reliably purely radial forces from components and allows axial offsets or axial play to not necessarily lead to increased wear and not be absorbed by a radial mounting, such as a radial bearing.

Another advantage of the torsional-vibration damper of the present invention is that it allows a cushioning/compensation of radial forces coming from the torsional-vibration damper directly at a torque-transfer point, thereby efficiently preventing damage to components, such as the clutch.

Another advantage of the torsional-vibration damper of the present invention is that it can achieve very low unbalances by coaxial positioning, facilitate mountability of a clutch module, absorb radial forces indirectly or directly by a carrier, and implement low eccentricities and, consequently, low unbalances by the secondary element being aligned with driving or driven shafts.

Another advantage of the torsional-vibration damper of the present invention is that it prevents damage to components due to wear in a most efficient way, can implement a substantially axially short form and particularly compact type of construction, and can support efficiently axial forces.

Another advantage of the torsional-vibration damper of the present invention is that it can absorb axial forces, the cause of which is attributable to radial offsets or unbalances, mitigate to a certain degree premature-wear phenomena of the torsional-vibration damper and of following components, and allow an axial positioning of damper-driven components, such as the clutch, with respect to the torsional-vibration damper.

Other objects, features, and advantages of the present invention will be readily appreciated as the same becomes better understood while reading the subsequent description taken in conjunction with the accompanying drawings.

### BRIEF DESCRIPTION OF THE DRAWINGS

FIG. 1 is an axial-half-sectional view of a first embodiment of a combination of a torsional-vibration damper and a double clutch of the present invention.

FIG. 2 is an axial-half-sectional view of a second embodiment of a combination of a torsional-vibration damper and a double clutch of the present invention.

FIG. 3 is an axial-half-sectional view of a third embodiment of a combination of a torsional-vibration damper and a double clutch of the present invention.

FIG. 4 is an axial-half-sectional view of a fourth embodiment of a combination of a torsional-vibration damper and a double clutch of the present invention.

FIG. 5 is a diagrammatical longitudinal-sectional view of an embodiment of a torsional-vibration damper of the present invention coupled to a crankshaft with a double clutch.

FIG. 6 is the diagrammatical longitudinal-sectional view of the embodiment of a torsional-vibration damper of the present invention coupled to a crankshaft with a double clutch shown in FIG. 5 with a different mounting.

FIG. 7 is a diagrammatical longitudinal-sectional view of an embodiment of a torsional-vibration damper of the present invention.

FIG. 8 is the diagrammatical longitudinal-sectional view of the embodiment of a torsional-vibration damper of the present invention shown in FIG. 7 with a different mounting.

FIG. 9 is a diagrammatical view of an embodiment of a torsional-vibration damper of the present invention with a double clutch and axial bearing points.

### DETAILED DESCRIPTION OF THE INVENTION

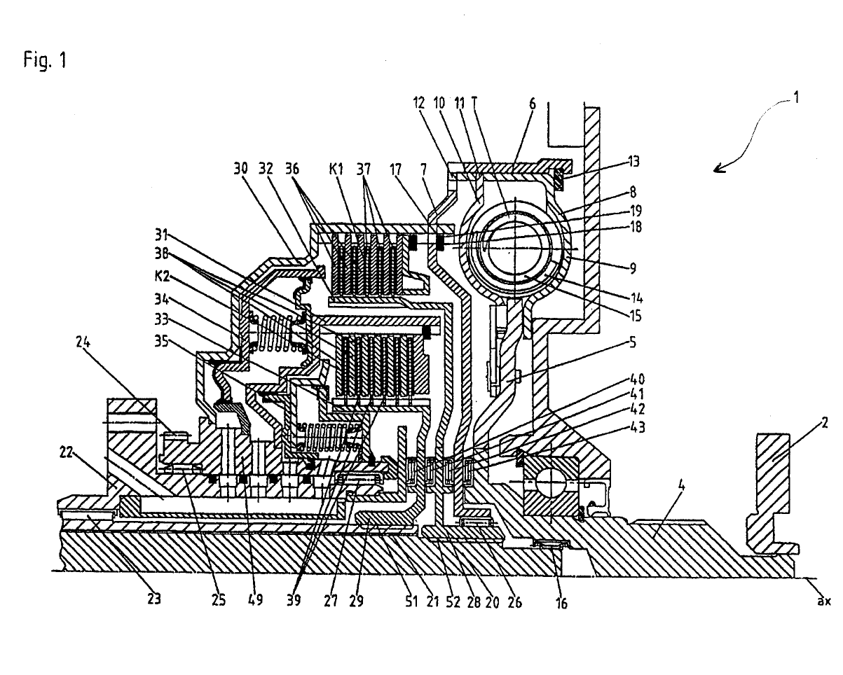

Referring now to the figures, where like numerals are used to designate like structure, a torsional-vibration damper of the present invention is indicated at “T” in FIGS. 1 through 4. The torsional-vibration damper T is adapted to be connected to a crankshaft 2 of a motor vehicle (not shown).

As shown in FIGS. 1 through 4, the torsional-vibration damper T includes, in general, a primary element 5 of a drive side thereof connected indirectly or directly to the crankshaft 2 substantially free of play in a direction along an axis (axis of rotation) “ax.” A secondary element 6 of an output side of the torsional-vibration damper T is substantially coaxially coupled rotatably and spring-elastically to the primary element 5 for transmission of rotational movement.

Preferably and as shown in FIGS. 1 through 9, the primary element 5 is connected to a flywheel 76, 108 that is connected to the crankshaft 2 substantially free of play in the axial direction “ax” or a flexible plate 105 that is connected to the crankshaft 2 with or without the flywheel 76, 108 being interposed. The primary element 5 is displaceable in the axial direction “ax” with respect to the secondary element 6. The primary element 5 or secondary element 6 is connected to a hollow ring in which spring elements 14, 15 for coupling the primary element 5 to the secondary element 6 are guided. The ring has at least one orifice for engagement of the other element 5, 6 and allowance of movement of the other element 5, 6 in the axial direction “ax.” The primary element 5 is mounted indirectly or directly in the axial direction “ax” on a rotatable part connected to the secondary element 6. Play of the rotatable part in the axial direction “ax” is greater than play of the crankshaft 2 in the axial direction “ax.” The primary element 5 is mounted substantially axially on a stationary clutch carrier 98. The primary element 5 is mounted radially indirectly or directly.

A joining connection between the primary element 5 and flywheel 76, 108 has a screw connection 106 and radial screw connection 107 for compensation of tolerances during assembly. The secondary element 6 has a radial needle bearing 26, 44, 45 for absorption of radial forces. The secondary element 6 is mounted rotatably—particularly radially by a rolling or plain bearing. The secondary element 6 includes a secondary sub-element 7, 8 that faces the output and/or drive side and is mounted rotatably—particularly radially.

The secondary element 6—particularly the secondary sub-element 7, 8 facing the output and/or drive side—is mounted indirectly or directly on a shaft 20 or non-rotating (stationary) carrier (clutch support) 22 carrying the torsional-vibration damper T [particularly on a transmission-input shaft 20 capable of being driven indirectly or directly via the torsional-vibration damper T, a primary hub (flange) 4 of the primary element 5, or a hub 28 of an inner lamella carrier (a half-shell) 32 of a radially outer clutch K1—particularly a double clutch K1, K2 (K2=a radially inner clutch)—capable of being driven indirectly or directly via the torsional-vibration damper T].

The secondary element 6 is mounted radially on a clutch housing or transmission housing—particularly on a housing cover. The secondary element 6—particularly the secondary sub-element 7, 8 facing the output and/or drive side—is mounted in the axial direction “ax”—particularly substantially axially on the primary element 5.

As shown in FIGS. 1 through 6 and 9, a combination (double-clutch device), generally indicated at 1, of the torsional-vibration damper T and the double clutch K1, K2 of the present invention includes, in general, the torsional-vibration damper T having the primary element 5 and the secondary element 6 being spring-elastically coupled to the primary element 5 and having the radial needle bearing 26 for absorption of radial forces. The double clutch K1, K2 has input elements (half-shells) 30, 31 to which the secondary element 6 is connected in a torque-transmitting manner, the inner lamella carrier (an output element) 32, and an output element (a half-shell) 33. The input and output elements 30, 31, 32, 33 are capable of being brought into and out of torque-transmission connection.

Preferably, the primary element 5 is joined to the crankshaft 2 substantially free of play in the axial direction “ax.” The secondary element 6 is mounted rotatably—particularly radially. The secondary element 6 includes the secondary sub-element 7, 8 facing the output and/or drive side and mounted rotatably—particularly radially—indirectly or directly on the shaft 20 or carrier 22 carrying the torsional-vibration damper T (preferably, on the transmission-input shaft 20 capable of being driven indirectly or directly via the torsional-vibration damper T, on the primary hub 4, or on the hub 28). The secondary element 6—particularly the secondary sub-element 7, 8 facing the output and/or drive side—is mounted in the axial direction “ax”—particularly substantially axially on the primary element 5 and/or on one side or both sides of the inner lamella carrier 32.

More specifically, FIG. 1 shows a first embodiment of the combination 1 of the torsional-vibration damper T and double clutch K1, K2 in a radially surrounding type of construction in axial-half section. The radially outer and inner clutches K1, K2 are arranged in a nested manner.

The torsional-vibration damper T is designed basically in a way that is conventional per se and includes the primary element 5 in the manner of a disk and the secondary element 6 with the output- and drive-side secondary sub-elements 7, 8 and drive- and output-side half-shells 9, 10 that are connected fixedly in terms of rotation to one another. The primary and secondary elements 5, 6 are coupled to one another via a spring device and rotatable with respect to one another about a neutral position. The spring device includes a plurality of the spring elements 14, 15—particularly, an outer helical spring 14 defining a diameter thereof and an inner helical spring 15 defining a diameter thereof smaller than that of the outer helical spring 14—that are arranged one behind the other in a circumferential direction and spaced apart from one another with aid of sliding shoes (not shown). The inner helical spring 15 passes centrally through the outer helical spring 14. A pair of the outer and inner helical springs 14, 15 is adjacent on an end face to one of the sliding shoes or end shoes (not shown).

The primary and secondary elements 5, 6 include in the diametrical arrangement two dogs that engage between a chain running in the circumferential direction and including the outer and inner helical springs 14, 15. In this way, a torque prevailing at the primary element 5 on the drive side can be transmitted by a primary dog (not shown) to the chain including the outer and inner helical springs 14, 15 and then to a secondary dog (not shown) of the secondary element 6.

As already mentioned, the secondary element 6 includes three individual parts—the drive-side half-shell 9, output-side half-shell 10, and output-side secondary sub-element 7 (an output-side half-shell 7). The drive-side and output-side half-shells 9, 10 are designed in such a way that they receive essentially positively the chain of the outer and inner helical springs 14, 15, are connected fixedly in terms of rotation to one another via a toothing 11, and serve for low-friction guidance of the outer and inner helical springs 14, 15, sliding shoes, and end shoes arranged in the circumferential direction between the pairs of the outer and inner helical springs 14, 15.

In addition to the half-shells 9, 10 receiving the outer and inner helical springs 14, 15, the output-side half-shell 7 is on the output side. The output-side half-shell 7 constitutes a coupling element with components following the torsional-vibration damper T—the double clutch K1, K2. The output-side half-shell 7 is connected fixedly in terms of rotation to the drive-side half-shell 9 via a toothing 12 in a similar way to the half-shell 10. The output-side half-shell 7 engages over the half-shell 9 in a radially outer region. With aid of a securing ring 13 and spring (not shown) between the output-side half-shells 7, 10, a substantially axially resilient fixing and connection of the output-side half-shells 7, 10 and drive-side half-shell 9 forming the secondary element 6 are obtained.

The double clutch K1, K2 in the radially nested arrangement is also set up in a way conventional per se and includes the radially outer and inner clutches K1, K2. The radially outer clutch K1 includes the input element (an outer lamella carrier) 30 and inner lamella carrier 32). A cylindrical part of the outer lamella carrier 30 has toothing on an inner circumference. Into toothing engages external toothing of outer lamellae 36 of the radially outer clutch K1 designed as steel lamellae. A cylindrical part of the inner lamella carrier 32 has on an outer circumference toothing into which engages internal toothing of inner lamellae 37 of the radially outer clutch K1 designed as lining lamellae. The outer and inner lamellae 36, 37 are introduced between cylindrical regions of the outer and inner lamella carriers 30, 32 in such a way that the outer lamellae 36 is followed in the axial direction “ax” by the inner lamellae 37 and vice versa. The outer and inner lamellae 36, 37 can be brought into and out of frictional engagement by an actuating piston 34 of the radially outer clutch K1.

The radially inner clutch K2 is also designed in a way identical per se to the radially outer clutch K1, including the input element (an outer lamella carrier) 31 and output element (an inner lamella carrier) 33. A cylindrical part of the outer lamella carrier 31 has on an inner circumference toothing into which engages external toothing of outer lamellae 38 of the radially inner clutch K2 designed as steel lamellae. A cylindrical part of the inner lamella carrier 33 has external toothing that can receive internal toothing of inner lamellae 39 of the radially inner clutch K2. One of the inner lamellae 39 is arranged adjacently to two of the outer lamellae 38, and one of the outer lamellae 38 is arranged adjacently to one of the inner lamellae 39 so as to form a stack of the outer and inner lamellae 38, 39. The outer and inner lamellae 38, 39 can be brought into and out of frictional engagement with aid of an actuating piston 35 of the radially inner clutch K2.

The stack of the outer and inner lamellae 38, 39 and a stack of the outer and inner lamellae 36, 37 are arranged so as to be nested radially with respect to one another. This means that the stack of the outer and inner lamellae 38, 39 is located radially within the stack of the outer and inner lamellae 36, 37 and approximately in the same axial portion.

The outer lamella carriers 30, 31 are connected fixedly in terms of rotation into one another via a clutch hub 49. The clutch hub 49, which is essentially in the form of a cylinder, is mounted rotatably on an outer circumference of the carrier 22. Rotatable mounting takes place via radial needle bearings 25, 27. The carrier 22 is likewise of essentially hollow-cylindrical design and has passing therethrough substantially coaxially the solid transmission-input shaft 20 and a hollow transmission-input shaft 21.

The primary element 5 is mounted rotatably on the transmission-input shaft 20, which is solid, via the primary hub 4 that is connected substantially free of play axially to the crankshaft 2. In this embodiment, the mounting is implemented with aid of a radial needle bearing 16.

The transmission-input shafts 20, 21 are connected fixedly in terms of rotation to one of the inner lamella carriers 32, 33. For this purpose, the inner lamella carrier 32 has the hub 28, and the inner lamella carrier 33 has hub 29. The hubs 28, 29 have on an inner circumference plug toothing 51, 52 for receiving toothings of the transmission-input shafts 20, 21.

The outer lamella carriers 30, 31 form the input elements of the double clutch K1, K2 while the inner lamella carriers 32, 33 form the output elements thereof. A torque introduced via the outer lamella carrier 30 can consequently be transmitted selectively, depending upon position of the actuating pistons 34, 35, to one of the inner lamella carriers 32, 33 and from there via the hubs 28, 29 to the transmission-input shafts 20, 21.

It is known from the related art to connect the output-side secondary sub-element 7 and outer lamella carrier 30 at a location (toothing) 17 with aid of a weld seam. In another version, the outer lamella carrier 30 and output-side secondary sub-element 7 are produced as one piece. In both instances, a sheet-metal part of the output-side secondary sub-element 7, which lies radially within the location 17, is absent. A torque generated by an internal-combustion engine (not shown) and transmitted to the torsional-vibration damper T via the crankshaft 2 can consequently be selectively transmitted, damped by the torsional-vibration damper T, to the solid or hollow transmission-input shaft 20, 21.

According to the related art, forces arising on the output side on account of unbalances cannot be absorbed within the torsional-vibration damper T. The present invention addresses this problem.

In this design variant according to FIG. 1, the output-side secondary sub-element 7 is not designed merely as a narrow ring with comparatively small radial dimensions. Instead, the output-side secondary sub-element 7 extends nearly to an outer radius of the hub 28. In this radially inner region, the output-side secondary sub-element 7 has a cylindrical shape. The radial needle bearing 26 is inserted between an inner circumference of a cylindrical portion of the output-side secondary sub-element 7 and an outer circumference of the hub 28. The radial needle bearing 26 supports the output-side secondary sub-element 7 radially and prevents a transfer of radial forces to the outer lamella carrier 30.

To keep any radial forces away from the double clutch K1, K2—particularly, the outer lamella carrier 30—there is no rigid connection between the outer lamella carrier 30 and output-side secondary sub-element 7. Instead, an open end of the outer lamella carrier 30 has toothing that engages with radial play into toothing of the output-side secondary sub-element 7.

Between the inner lamella carriers 32, 33, which partially run essentially radially, and the output-side secondary sub-element 7, axial needle bearings 41, 42 space apart substantially axially the inner lamella carriers 32, 33 and the output-side secondary sub-element 7. Between the output-side secondary sub-element 7 and the primary element 5 is located an axial needle bearing 43. An axial needle bearing 40 is between the inner lamella carrier 33 and a half-shell 53 connected fixedly in terms of rotation to the carrier 22. The axial needle bearings 40, 41, 42, 43 serve, on the one hand, for low-friction guidance of the output-side half-shell 7 and half-shells 32, 33, which are rotationally movable with respect to one another, and, on the other hand, for supporting the axial direction “ax”—setting of axial play taking place with aid of a securing ring 18 and cup spring 19 at the location 17 of a transfer of torque from the torsional-vibration damper T to the outer lamella carrier 30.

It is apparent from this embodiment that the present invention can readily be implemented by use of existing sheet-metal parts with aid of which the output-side secondary sub-element 7 is shaped in the form of an additional cover. Thus, from an existing damper housing that has hitherto been stamped out to a large diameter and/or connected to the outer lamella carrier 30, an inner region of the sheet blank can be used to produce a necessary cover shape. By skillful arrangement of the sheet-metal parts, a bearing point according to the present invention can be produced so as to be virtually neutral in terms of construction space.

Furthermore, the present invention makes it possible to configure setting of overall clutch play independently of damper-play setting. This, in turn, makes it possible to install damper structures that dispense completely with play setting or of which the primary side, as a flexible element, makes the clutch/damper unit independent of axial movements of the crankshaft 2.

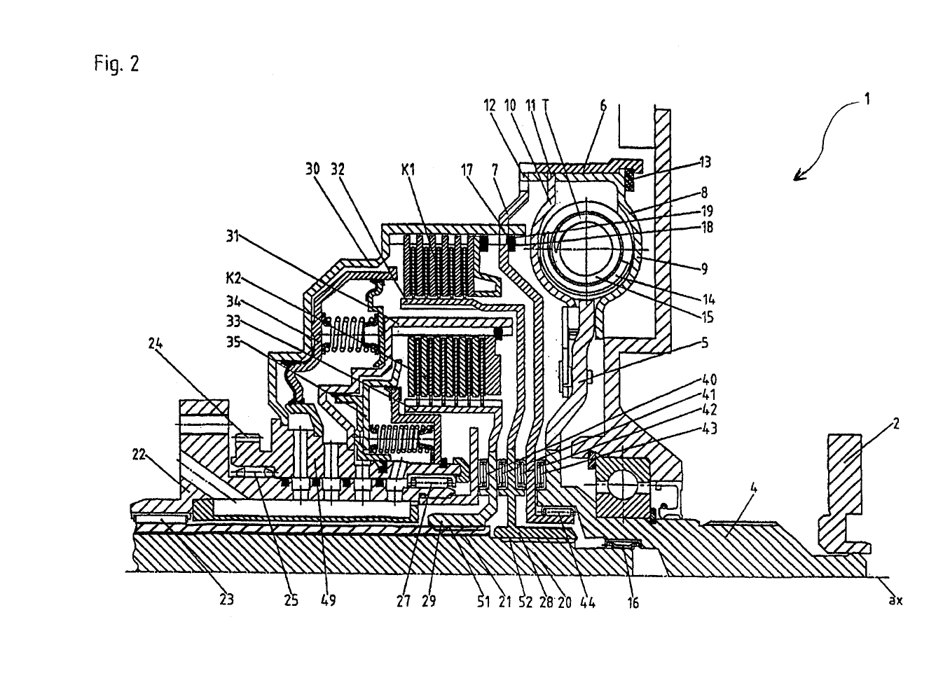

Referring now to FIG. 2, a second embodiment of the combination 1 of the torsional-vibration damper T and double clutch K1, K2 in the radially nested arrangement according to the present invention is shown in axial-half section. The combination 1 according to FIG. 2 is designed virtually identically to the combination 1 according to FIG. 1. As such, similar or like parts of the combination 1 of the second embodiment with respect to the combination 1 of the first embodiment have similar or like reference numerals as those of the combination 1 of the first embodiment. Only differences between the two embodiments are described immediately below.

The combination 1 according to FIG. 2 differs from that according to FIG. 1 only in that, in the former, there is not the radial needle bearing 26 located between the output-side secondary sub-element 7 and the hub 28. On the contrary, instead of the radial needle bearing 26, a radial needle bearing 44 is arranged between an outer circumference of the hollow, cylindrical, radially inner end of the output-side secondary sub-element 7 and an inner circumference of the primary hub 4. An absorption of radial forces introduced via the torsional-vibration damper T takes place.

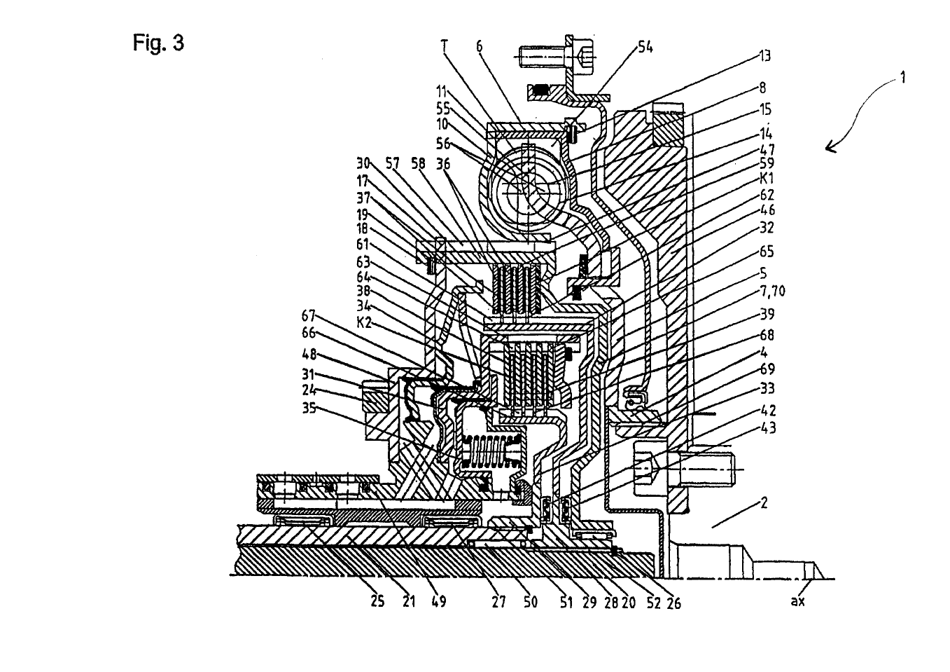

Referring now to FIG. 3, a third embodiment of the combination 1 of the torsional-vibration damper T and double clutch K1, K2 in the radially nested arrangement according to the present invention is shown in axial-half section. The torsional-vibration damper T according to FIG. 3 is designed basically in a way that is conventional per se and includes the primary element 5 in the manner of a disk and the secondary element 6 with the output-side half-shell 7 and the drive-side secondary sub-element 8 (a drive-side half-shell 8) that are connected fixedly in terms of rotation to one another. The primary and secondary elements 5, 6 are coupled to one another via a spring device and rotatable with respect to one another about a neutral position. The spring device includes a plurality of helical spring sets arranged one behind another in the circumferential direction. A helical spring set has an inner spring 15 and outer spring 15 surrounding the inner spring 15. Adjacent helical spring sets are spaced apart from one another with aid of sliding shoes (spring dividers) 54.

The primary and secondary elements 5, 6 include, in a diametrical arrangement, two dogs that are inserted between the chain of the outer and inner helical springs 14, 15 that runs in the circumferential direction. In this way, a torque introduced into the primary element 5 on the drive side is transmitted by a primary dog 55, shown in FIG. 1, to the chain of the outer and inner helical springs 14, 15 and then to a secondary dog 56 of the secondary element 6.

The output-side and drive-side half-shells 7, 8 are designed in such a way that they receive essentially positively the chain of the outer and inner helical springs 14, 15. The half-shells 9, 10 are connected fixedly in terms of rotation to one another via the toothing 11 and secured so as to be essentially non-displaceable substantially axially with respect to one another with aid of the securing ring 13 engaging into a circumferential groove of the output-side half-shell 7. The output-side and drive-side half-shells 7, 8 serve for low-friction guidance of the outer and inner helical springs 14, 15 or sliding shoes 54 arranged between the outer and inner helical springs 14, 15 in the circumferential direction.

The double clutch K1, K2 in the radially nested arrangement is also set-up in a way that is conventional per se and includes the radially outer and inner clutches K1, K2. The stack of the outer and inner lamellae 38, 39 is arranged radially within the stack of the outer and inner lamellae 36, 37. Furthermore, the stacks of the outer and inner lamellae 36, 38, 37, 39 are arranged approximately in the same axial portion.

The radially outer clutch K1 includes the outer lamella carrier 30 and inner lamella carrier 32. A cylindrical part 57 of the outer lamella carrier 30 has a toothing 58 on an inner circumference. Into the toothing 58 engages an external toothing 59 of the outer lamellae 36. A cylindrical part 60 of the inner lamella carrier 32 has on an outer circumference an external toothing 61 into which engages an internal toothing 62 of the inner lamellae 37. The outer and inner lamellae 36, 37 are introduced between the cylindrical parts 57, 60 of the outer and inner lamella carriers 30, 32 in such a way that the outer lamella 36 is followed in the axial direction “ax” by the inner lamella 37 and vice versa. The outer and inner lamellae 36, 37 can be brought into and out of frictional engagement by the actuating piston 34.

The radially inner clutch K2 is designed basically in the same way as is the radially outer clutch K1. A cylindrical part 63 of the outer lamella carrier 31 has on an inner circumference an internal toothing 64 into which an external toothing 65 of the outer lamellae 38 engages. A cylindrical part 66 of the inner lamella carrier 33 has an external toothing 67 that receives internal toothings 68 of the inner lamellae 39. One of the inner lamellae 39 is thus arranged adjacently to two of the outer lamellae 38, and one of the outer lamellae 38 is arranged adjacently to two of the inner lamellae 39 so as to form the stack of the outer and inner lamellae 38, 39. The outer and inner lamellae 38, 39 can be brought into and out of frictional engagement with aid of the actuating piston 35.

The outer lamella carrier 31 is connected fixedly in terms of rotation to the clutch hub 49. Furthermore, a rotationally fixed connection between the outer lamella carrier 30 and a side disk (half-shell) 48 welded to the clutch hub 49 and carrying a pump-drive gearwheel 24 is made with aid of the toothing 17. The clutch hub 49, which is essentially in the form of a cylinder, is mounted rotatably about the axis of rotation “ax” on an outer circumference of the hollow transmission-input shaft 21. The rotatable mounting takes place via the radial needle bearings 25, 27.

The hollow transmission-input shaft 21 has passing centrally therethrough the solid transmission-input shaft 20 and is mounted rotatably on the solid transmission-input shaft 20 by a radial needle bearing 50. The hollow transmission-input shaft 21 is connected via the plug toothing 51 to the hub 29. The solid transmission-input shaft 20 is connected fixedly in terms of rotation via the plug toothing 52 to the hub 28.

The clutch hub 49 and outer lamella carrier 30, which is connected fixedly in terms of rotation to the clutch hub 49, form the input elements of the double clutch K1, K2 while the inner lamella carriers 32, 33 form the output elements thereof. Consequently, a torque introduced via the outer lamella carrier 30 or clutch hub 49 is transmitted selectively, depending upon position of the actuating pistons 34, 35, to the solid or hollow transmission-input shaft 20, 21 via one of the inner lamella carriers 32, 33.

The input and output sides are connected rigidly to one another via a weld seam 47 between the output-side secondary sub-element 7 and cylindrical part 57. Furthermore, a rotationally fixed connection between the primary hub 4 and an input flywheel mass 46 is made via a plug toothing 69. The flywheel mass 46, in turn, is connected on an input side to the crankshaft 2 that can be driven by the internal-combustion engine.

If it is assumed that the internal-combustion engine generates a torque, then this is conducted via the crankshaft 2 and the flywheel mass 46—connected substantially free of play axially to the crankshaft 2—to the primary element 5. Radial vibrations are damped by the outer and inner helical springs 14, 15, and the torque is transmitted to the secondary element 6. The secondary element 6 transmits the torque to the outer lamella carriers 30, 31 via the half-shell 48 and clutch hub 49. Depending upon position of the actuating pistons 34, 35, a transfer of the torque to the solid or hollow transmission-input shaft 20, 21 takes place via one of the inner lamella carriers 32, 33.

As already stated, there is basically a need to support radial forces on the secondary element 6. In this embodiment, such takes place in that an annular disk-shaped part 70 forms radially inward virtually a prolongation of the output-side half-shell 7, runs cylindrically on an inner circumferential area, and is radially mounted and supported in the area against an outer circumference of the hub 28 by the radial needle bearing 26. No radial force is transmitted to remaining clutch components because, owing to the toothing 17 between the outer lamella carrier 30 and side disk 48, a certain radial movement is possible between the outer lamella carrier 30 and side disk 48.

Clutch play is set via the securing ring 18 and cup spring 19 at an outer edge of the double clutch K1, K2. Axial displaceability is fixed radially on an inside by the axial needle bearings 42, 43 that are arranged between the inner lamella carriers 32, 33 and the outer lamella carrier 30.

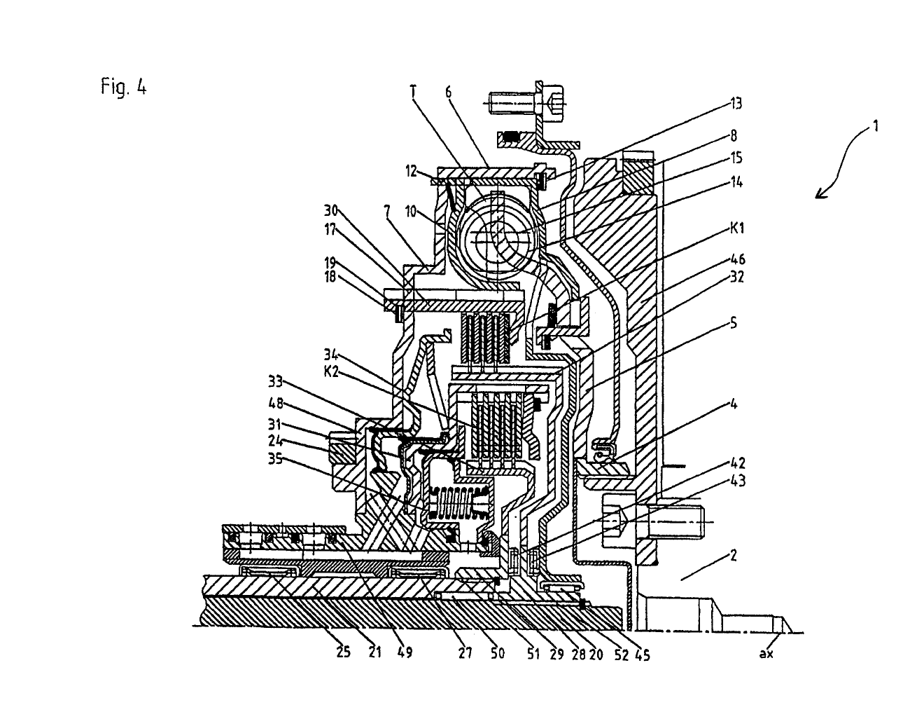

Referring now to FIG. 4, a fourth embodiment of the combination 1 of the torsional-vibration damper T and the double clutch K1, K2 in the radially nested arrangement according to the present invention is shown in axial-half section. The combination 1 according to FIG. 4 is designed virtually identically to the combination 1 according to FIG. 3. As such, similar or like parts of the combination 1 of the fourth embodiment with respect to the combination 1 of the third embodiment have similar or like reference numerals as those of the combination 1 of the third embodiment. Only differences between the two embodiments are described immediately below.

Contrary to the design variant according to FIG. 3, in that according to FIG. 4, a torque-transfer point from the torsional-vibration damper T to the double clutch K1, K2 is not at the weld seam 47 between the output-side half-shell 10 and outer lamella carrier 30. Instead, such point is at the toothing 17. For this purpose, the side disk 48 is designed as an output-side secondary sub-element similar to the type described in relation to FIGS. 1 and 2.

Radial support mounting does not take place via the output-side half-shell 10, formed partially by the outer lamella carrier 30, as in the design variant according to FIG. 3. Instead, such mounting takes place via the drive-side half-shell 8, which, for this purpose, is designed to be prolonged radially inward, issues into a cylindrical portion, and herein adjoins on an inner circumference a radial needle bearing 45 that is seated on an outer circumference of the hub 28.

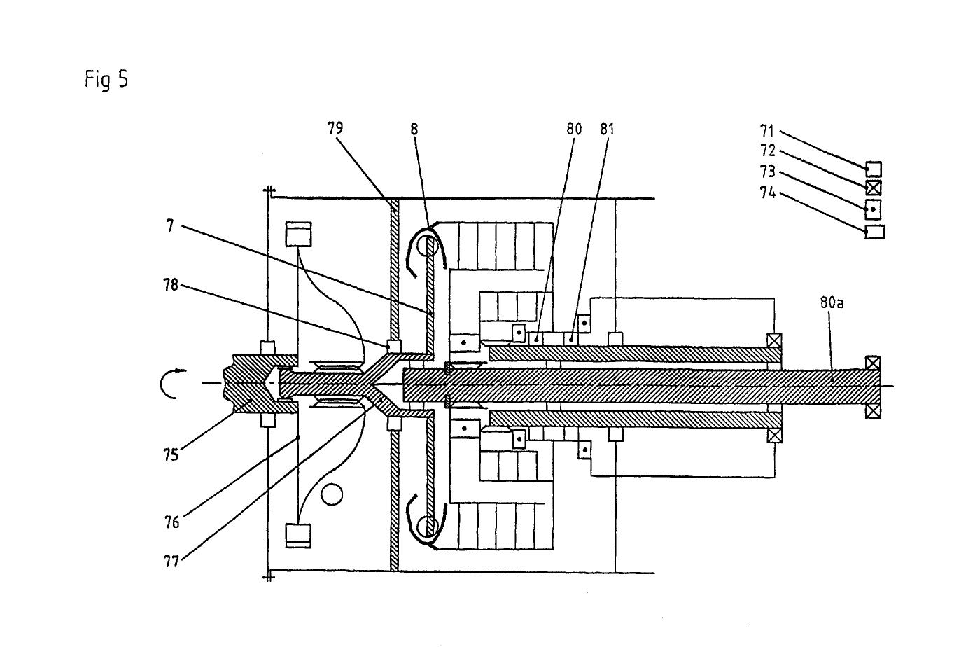

FIG. 5 shows on the drive side a part 75 of the crankshaft 2 that carries the flywheel 76. A shaft (primary flange) 77 forming a prolongation of the crankshaft 2 is mounted radially at one end in a loose bearing 78 on a transmission cover 79 and at the other end on a transmission shaft 80a.

The shaft 77 carries the output-side secondary sub-element 7. The shaft 77 and output-side secondary sub-element 7 are not mounted in the axial direction “ax,” but are subject to axial movements imparted by the crankshaft 2 to which they are coupled substantially free of play axially. For this purpose, the output-side secondary sub-element 7 has axial play within half-shells that form portions of the drive-side secondary sub-element 8 so that axial movements of the crankshaft 2 can be absorbed. The drive-side secondary sub-element 8 is mounted radially in, for example, bearings 80, 81 via the output-side clutch.

FIG. 5 shows various types of bearings—loose bearings 71 (only radially guiding bearings), fixed bearings 72 that guide both in the radial direction and axial direction “ax,” axial bearings 73 for only mounting in the axial direction “ax,” and radial supporting bearings 74. In the configuration illustrated, axial movements of the crankshaft 2, such as those that naturally occur in the internal-combustion engine, do not in any event lead to transmission of such movements to the clutch.

Individual parts of a drive chain—that is to say, the crankshaft 2, the shaft 77, and the output-side secondary sub-element 7—are connected to one another substantially free of play in the axial direction “ax” by, for example, welding, shrinking, or screwing so that relative movement of these parts with respect to one another is also avoided, and, therefore, no noises or unbalances can arise. Radial mounting of the shaft 77 and, consequently, output-side secondary sub-element 7 in the loose bearing 78 on the transmission cover 79 additionally gives rise to an accurate running of drive elements in the radial direction and, consequently, to avoidance of unbalances or irregularities in the transmission of rotational movement within the torsional-vibration damper T.

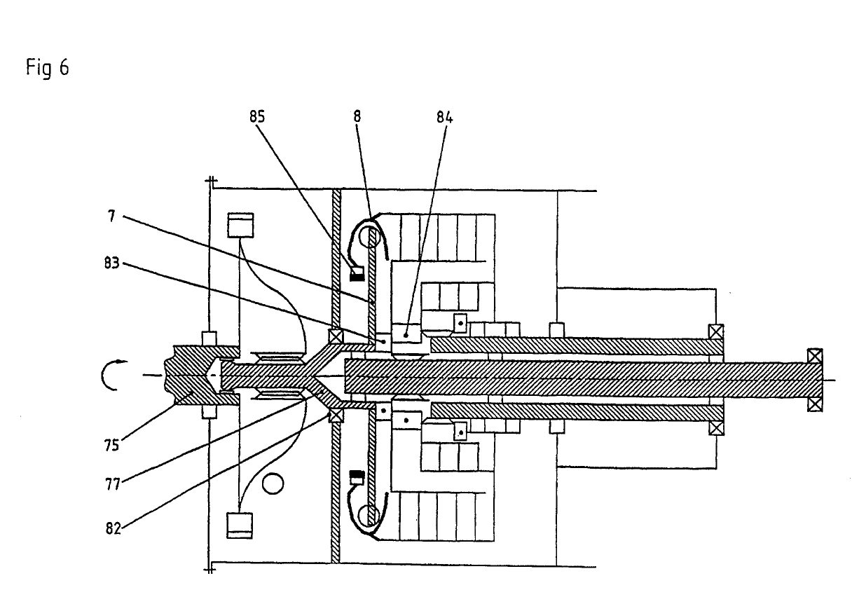

Additionally and alternatively to the design illustrated in FIG. 5, FIG. 6 shows the shaft 77 being mounted in a fixed bearing 82, and an axial mounting of the shaft 77 in bearings 83, 84 with respect to parts of the clutch takes place. In this case, it is important for functioning of the present invention that axial play of the bearings 83, 84 be greater than expected axial movements of the crankshaft 2. Movements of the output-side secondary sub-element 7 can then also be absorbed in the torsional-vibration damper T by axial play with respect to the drive-side secondary sub-element 8. In contrast to the configuration of FIG. 5, the drive-side secondary sub-element 8 is additionally supported with respect to the output-side secondary sub-element 7 by a radial bearing 85. Thus, radial unbalances between the output-side secondary sub-element 7 and drive-side secondary sub-element 8, which could lead to generation of noise and excessive wear and movement unbalances, are minimized.

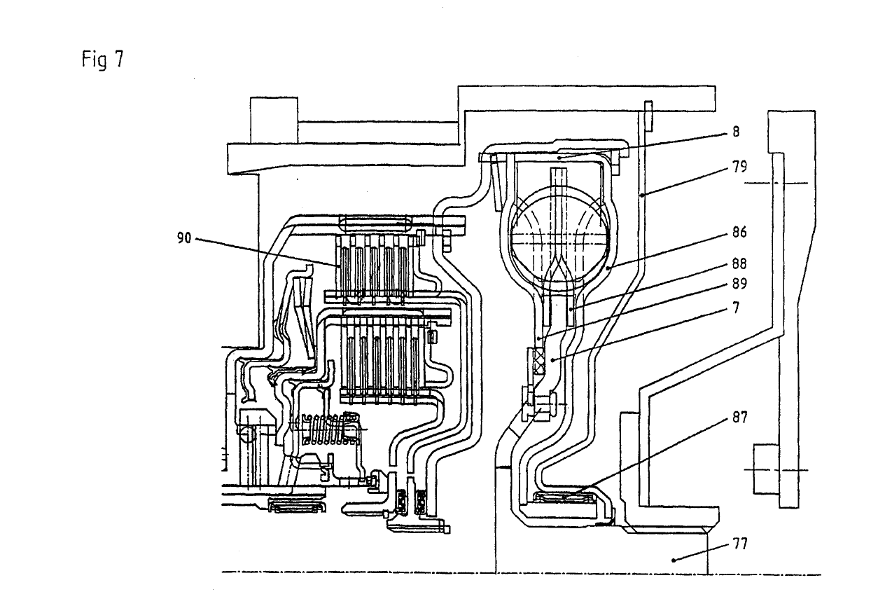

FIG. 7 shows a mounting of the drive-side secondary sub-element 8 on the transmission cover 79 via a drive-side half-shell 86 and radially inward leading extension thereof by a radial mounting 87. The figure shows also axial play 88 between the output-side secondary sub-element 7 and the drive-side half-shell 86, a half-shell 89, and an output-side clutch 90. An axial mounting of the output-side secondary sub-element 7 or parts of the drive chain that are connected thereto is/are not in the design illustrated in FIG. 7.

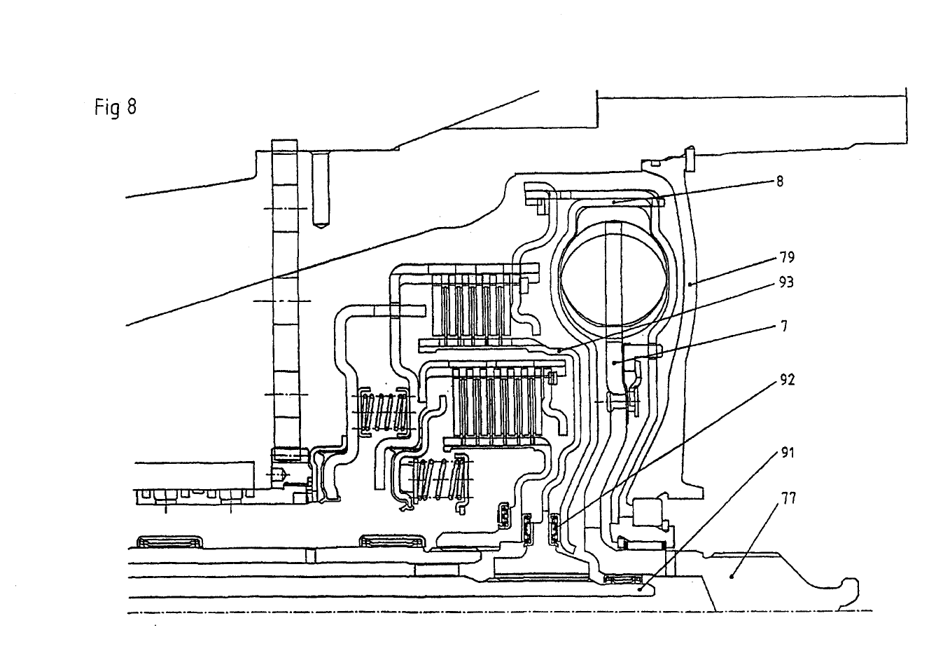

FIG. 8 shows a part, connected to the crankshaft 2, of the shaft 77 to which the output-side secondary sub-element 7 is firmly attached. The shaft 77 is mounted radially with respect to a transmission shaft 91. There is not an axial mounting of the output-side secondary sub-element 7. The figure shows also a drive-side half-shell of the drive-side secondary sub-element 8 being mounted with respect to the transmission housing, particularly the transmission cover 79. There is an axial mounting 92 with respect to an inner lamella carrier 93.

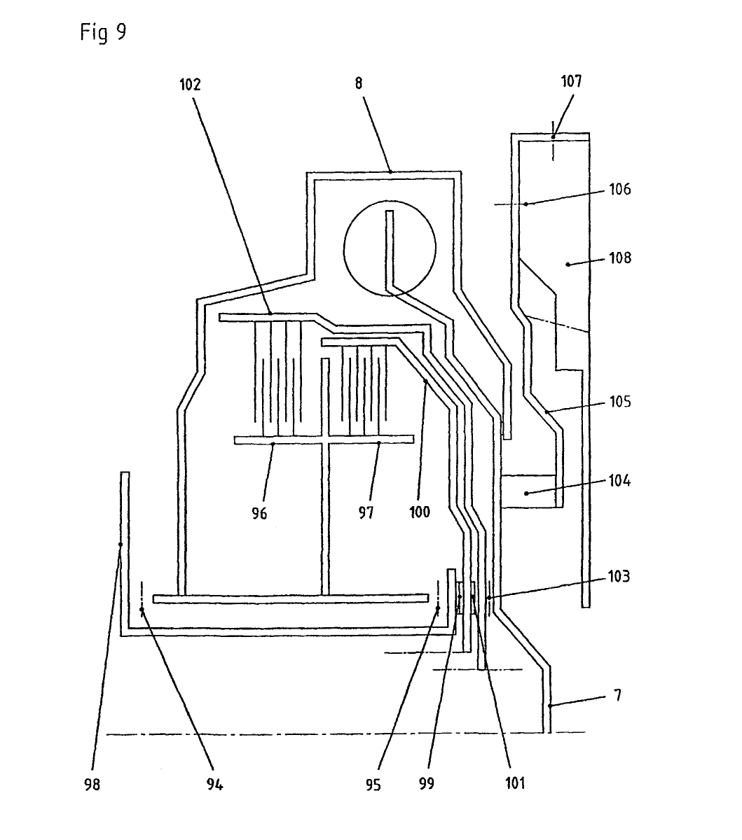

FIG. 9 shows diagrammatically in an overview possible axial mounting points of an overall arrangement—particularly in axial bearings 94, 95 that support inner lamella carriers 96, 97 radially with respect to the clutch carrier 98, an axial bearing 99 that supports an outer lamella carrier 100 substantially axially with respect to the clutch carrier 98, and an axial bearing 101 for axial support between the outer lamella carrier 100 and an outer lamella carrier 102. There is an axial bearing 103 for supporting the output-side secondary sub-element 7 with respect to the outer lamella carrier 102.

The output-side secondary sub-element 7 is joined together by a welded joint or screw connection with a torsional-vibration-damper hub 104 that is connected to the flexible plate 105. The flexible plate 105 is connected to the flywheel 108 by the screw connection 106 having axial screws and/or the radial screw connection 107. In the case of the screw connection 106 and radial screw connection 107, long holes may make it possible to set tolerance compensation between the output-side secondary sub-element 7 and flexible plate 105, flywheel 108, and crankshaft 2.

Connection free of axial play between the output-side secondary sub-element 7, flexible plate 105, flywheel 108, and part (not shown) of the crankshaft 2 or a shaft connected fixedly thereto is fundamentally important in the present invention. As a result, noises, unbalances, and wear that could arise due to axial relative movements are avoided.

It should be appreciated by those having ordinary skill in the related art that the combination 1, in general, and each of the torsional-vibration damper T and double clutch K1, K2, in particular, can have any suitable shape, size, and structure. It should be so appreciated also that the torsional-vibration damper T and double clutch K1, K2 can have any suitable structural relationship with each other. It should be so appreciated also that each of the components of each of the torsional-vibration damper T and double clutch K1, K2 can have any suitable shape, size, and structure. It should be so appreciated also that the components of the torsional-vibration damper T can have any suitable structural relationship with each other and those of the double clutch K1, K2 can have any suitable structural relationship with each other. It should be so appreciated also that the components of the torsional-vibration damper T can have any suitable structural relationship with the double clutch K1, K2. It should be so appreciated also that the torsional-vibration damper T can be connected to the crankshaft 2 in any suitable manner.

The torsional-vibration damper T and components connected on the output side tend to prematurely wear to a lesser extent than do systems or torsional-vibration dampers according to the related art, and generation of noise during operation of the torsional-vibration damper T is reduced. Also, play-free connections may be configured as fixed or even releasable joining connections, and play-free coupling may be configured in the axial direction “ax” to initially prevent generation of noise and relative movement between the crankshaft 2 and, if appropriate, flywheel 76, 108, flexible plate 105, and primary element 5, depending upon which parts are in a drive chain. Furthermore, unavoidable movements can be absorbed particularly simply in the axial direction “ax” during a drive movement of the crankshaft 2 in a region of the torsional-vibration damper T at a low outlay in structural terms. In addition, the primary element 5 is connected to the flywheel 76, 108, which is connected substantially free of play axially to the crankshaft 2, and a joining connection is between the primary element 5 and flywheel 76, 108 for compensation of tolerances during assembly. Moreover, dampening of irregular movements may be reinforced, vibrations may be dampened, radial or axial offsets and tiltings of axes of rotation with respect to one another may be compensated, and axial play in the drive train between the internal-combustion engine, crankshaft 2, and torsional-vibration damper T is effectively limited. Plus, movement of the primary or secondary element 5, 6 in the axial direction “ax” for compensation of axial movement of the other element 5, 6 is allowed, the primary element 5 is mounted indirectly or directly in the axial direction “ax” on a rotatable part connected to the secondary element 6, and play of the rotatable part in the axial direction “ax” is greater than axial play of the crankshaft 2 and primary element 5.

Rattling noises and a higher wear or noise generation due to unbalances are reduced, wear due to axial knocking by individual parts being mounted against one another in the axial direction “ax” is prevented, and a more exact tie-up to the secondary element 6 is achieved. Also, during assembly, the drive train is allowed to be joined together with unbalances as minimized as possible, thus leading to an increase in synchronism both in the axial direction “ax” and circumferential direction. Furthermore, space and an effective shielding, absorbing, or compensating of radial forces, which is an integral part of the secondary element 6, are provided, and parasitically occurring radial forces are prevented from being transferred to following components, such as the double clutch K1, K2. In addition, overall clutch play is allowed to be set independently of a play setting on the torsional-vibration damper T such that damper structures may be used that dispense completely with the play setting, or the primary element 5, as a flexible element, makes the double clutch K1, K2/torsional-vibration damper T independent of axial movements of a drive shaft, such as the crankshaft 2. Moreover, purely radial forces are shielded reliably from components, and axial offsets or axial play are/is allowed to not necessarily lead to increased wear and not be absorbed by a radial mounting, such as a radial bearing. Plus, a cushioning/compensation of radial forces coming from the torsional-vibration damper T directly at a torque-transfer point is allowed, thereby efficiently preventing damage to components, such as the double clutch K1, K2.

Very low unbalances can be achieved by coaxial positioning, mountability of a clutch module can be facilitated, radial forces can be absorbed indirectly or directly by a carrier, and low eccentricities and, consequently, low unbalances can be implemented by the secondary element 6 being aligned with driving or driven shafts. Also, damage to components due to wear is prevented in a most efficient way, a substantially axially short form and particularly compact type of construction can be implemented, and axial forces can be supported efficiently. Furthermore, axial forces, the cause of which is attributable to radial offsets or unbalances, can be absorbed, premature-wear phenomena of the torsional-vibration damper T and of following components can be mitigated to a certain degree, and an axial positioning of damper-driven components, such as the double clutch K1, K2, can be allowed with respect to the torsional-vibration damper T.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A torsional-vibration damper (T) adapted to be connected to a crankshaft (2) of a motor vehicle, said torsional-vibration damper (T) comprising:
a primary element (5) of a drive side of said torsional-vibration damper (T) connected either of indirectly and directly to the crankshaft (2) substantially free of play in an axial direction (ax); and
a secondary element (6) of an output side of said torsional-vibration damper (T) substantially coaxially coupled rotatably and spring-elastically to said primary element (5) for transmission of rotational movement.

2. A torsional-vibration damper (T) as set forth in claim 1, wherein said primary element (5) is connected to a flywheel (76, 108) that is connected to the crankshaft (2) substantially free of play in said axial direction (ax).

3. A torsional-vibration damper (T) as set forth in claim 1, wherein said primary element (5) is connected to a flexible plate (105) that is connected to the crankshaft (2) either of with and without a flywheel (76, 108) being interposed.

4. A torsional-vibration damper (T) as set forth in claim 1, wherein said primary element (5) is displaceable in said axial direction (ax) with respect to said secondary element (6).

5. A torsional-vibration damper (T) as set forth in claim 4, wherein either of said primary and secondary elements (5, 6) is connected to a ring in which spring elements (14, 15) for coupling said primary element (5) to said secondary element (6) are guided, wherein said ring has at least one orifice for engagement of other element (5, 6) of said either of said primary and secondary elements (5, 6) and allowance of movement of said other element (5, 6) in said axial direction (ax).

6. A torsional-vibration damper (T) as set forth in claim 2, wherein said primary element (5) is mounted either of indirectly and directly in said axial direction (ax) on a rotatable part connected to said secondary element (6), wherein play of said rotatable part in said axial direction (ax) is greater than play of the crankshaft (2) in said axial direction (ax).

7. A torsional-vibration damper (T) as set forth in claim 2, wherein said primary element (5) is mounted substantially axially on a clutch carrier (98).

8. A torsional-vibration damper (T) as set forth in claim 1, wherein said primary element (5) is mounted radially either of indirectly and directly.

9. A torsional-vibration damper (T) as set forth in claim 2, wherein a joining connection between said primary element (5) and said flywheel (76, 108) has screw connections (106, 107) for compensation of tolerances during assembly.

10. A torsional-vibration damper (T) as set forth in claim 1, wherein said secondary element (6) has a radial needle bearing (26, 44, 45) for absorption of radial forces.

11. A torsional-vibration damper (T) as set forth in claim 10, wherein said secondary element (6) is mounted rotatably.

12. A torsional-vibration damper (T) as set forth in claim 11, wherein said secondary element (6) is mounted radially.

13. A torsional-vibration damper (T) as set forth in claim 12, wherein said secondary element (6) is mounted radially by either of a rolling bearing and plain bearing.

14. A torsional-vibration damper (T) as set forth in claim 10, wherein said secondary element (6) includes a secondary sub-element (7) that faces at least one of said output and drive sides and is mounted rotatably.

15. A torsional-vibration damper (T) as set forth in claim 10, wherein said secondary element (6) is mounted rotatably either of indirectly and directly on either of a shaft (20) and carrier (22) carrying said torsional-vibration damper (T).

16. A torsional-vibration damper (T) as set forth in claim 15, wherein said secondary element (6) is mounted rotatably either of indirectly and directly on any of a transmission-input shaft (20) capable of being driven either of indirectly and directly via said torsional-vibration damper (T), a primary hub (4) of said primary element (5), and a hub (28) of an inner lamella carrier (32) of a clutch (K1) capable of being driven either of indirectly and directly via said torsional-vibration damper (T).

17. A torsional-vibration damper (T) as set forth in claim 10, wherein said secondary element (6) is mounted radially on either of a clutch housing and a transmission housing.

18. A torsional-vibration damper (T) as set forth in claim 17, wherein said secondary element (6) is mounted radially on a housing cover.

19. A torsional-vibration damper (T) as set forth in claim 1, wherein said secondary element (6) is mounted in said axial direction (ax).

20. A torsional-vibration damper (T) as set forth in claim 19, wherein said secondary element (6) is mounted substantially axially on said primary element (5).

21. A combination (1) of a torsional-vibration damper (T) and a double clutch (K1, K2), said combination (1) comprising:
a torsional-vibration damper (T) including:
a primary element (5) of a drive side of said torsional-vibration damper (T); and
a secondary element (6) of an output side of said torsional-vibration damper (T) being spring-elastically coupled to said primary element (5) and having a radial needle bearing (26) for absorption of radial forces; and
a double clutch (K1, K2) including:
an input element (30, 31) to which said secondary element (6) is connected in a torque-transmitting manner; and
an output element (32, 33), wherein said input and output elements (30, 31, 32, 33) are capable of being brought into and out of torque-transmission connection.

22. A combination (1) of a torsional-vibration damper (T) and a double clutch (K1, K2) as set forth in claim 21, wherein said primary element (5) is joined to a crankshaft (2) substantially free of play in an axial direction (ax).

23. A combination (1) of a torsional-vibration damper (T) and a double clutch (K1, K2) as set forth in claim 21, wherein said secondary element (6) is mounted rotatably.

24. A combination (1) of a torsional-vibration damper (T) and a double clutch (K1, K2) as set forth in claim 23, wherein said secondary element (6) is mounted radially.

25. A combination (1) of a torsional-vibration damper (T) and a double clutch (K1, K2) as set forth in claim 23, wherein said secondary element (6) includes a secondary sub-element (7, 8) facing at least one of said output and drive sides and mounted rotatably.

26. A combination (1) of a torsional-vibration damper (T) and a double clutch (K1, K2) as set forth in claim 23, wherein said secondary element (6) is mounted rotatably either of indirectly and directly on either of a shaft (20) and a non-rotating carrier (22) carrying said torsional-vibration damper (T).

27. A combination (1) of a torsional-vibration damper (T) and a double clutch (K1, K2) as set forth in claim 26, wherein said secondary element (6) is mounted rotatably either of indirectly and directly on any of a transmission-input shaft (20) capable of being driven either of indirectly and directly via said torsional-vibration damper (T), a primary hub (4) of said primary element (5), and a hub (28) of a radially outer clutch (K1).

28. A combination (1) of a torsional-vibration damper (T) and a double clutch (K1, K2) as set forth in claim 23, wherein said secondary element (6) is mounted in an axial direction (ax).

29. A combination (1) of a torsional-vibration damper (T) and a double clutch (K1, K2) as set forth in claim 28, wherein said secondary element (6) is mounted substantially axially on at least one of said primary element (5) and at least one side of said output element (32, 33) of said radially outer clutch (K1).
